(19) United States
(12) Patent Application Publication
(10) Pub. No.: US 2015/0030737 A1
(43) Pub. Date: Jan. 29, 2015

(54) Apparatus for Preparing a Temperature Sensitive Beverage

(71) Applicant: J Morrone Consulting, LLC, Wakefield, RI (US)

(72) Inventor: Joseph Morrone, Wakefield, RI (US)

(73) Assignee: J Morrone Consulting, LLC, Wakefield, RI (US)

(21) Appl. No.: 13/949,061

(22) Filed: Jul. 23, 2013

(51) Int. Cl. A47J 31/40; A47J 31/44; A23L 1/29

(52) U.S. Cl. CPC A47J 31/401; A23L 1/296; A47J 31/4457
USPC 426/388; 206/459.5

(57) ABSTRACT

A flask has a body, base, mouth, and one or more indicia to enable preparation of beverages with a desired temperature. Specific embodiments include the preparation of baby formula and tea. The one or more indicia can show one or more levels, quantities, or both. A level or quantity contained within the flask has a proper percentage of liquid, as calculated and so embedded as a feature into the flask, while the corresponding indicium on the flask for the level or quantity shows the total amount of liquid needed, so that the preparation of temperature sensitive beverage with a desired temperature will be convenient and quick. In another aspect, a method for preparing a temperature sensitive beverage fills a flask up to a volume shown by one or more indicia, heats the liquid in the flask, and combines the heated liquid with unheated liquid to attain a beverage with a desired final volume and a desired final temperature.

### BACKGROUND OF THE INVENTION

Beverages such as tea and baby formula are often made at certain temperature ranges. In the case of tea, loose tea can be brewed at certain temperatures to enhance flavor. A common way to prepare loose tea is to boil water and allow the water to cool to the proper temperature before brewing the tea. Tea users generally wait for the water to cool to the proper temperature. If the water is left to cool too long, the temperature of the water will be too low, and it will have to be reheated a second time until the water temperature is in the proper range. All of this necessitates waiting, sometimes more than once.

With respect to baby formula, formula is prepared to be close to body temperature so as to mimic the temperature of breast milk. One common way of preparing baby formulas (e.g., infant formulas) is to mix a preparation, which can be in powder or liquid form, with water. Because the water used to prepare the formula is typically at the temperature of the environment, which is usually lower than that of the human body, it is necessary to heat the water or the mixture to a temperature as close as possible to the body's temperature. Another reason not to use water at temperatures lower than the body temperature is that potentially harmful bacteria, such as Cronobacter sakazakii, can remain active at these lower temperatures. Current methods of preparing formulas include heating the water using a pan or a microwave and then letting the water cool down to the desired temperature while periodically checking it. The checks are often performed via crude methods such as touching the side of a baby bottle with one's wrists to feel its temperature. Often, such methods are not sufficiently precise to achieve a proper formula temperature. As is in the case of tea preparation, heating and cooling water when preparing baby formula is time consuming.

Accordingly, a need exists to better prepare temperature sensitive beverages such as tea or baby formula at a proper temperature. A further need exists to do so more precisely and in less time.

### SUMMARY OF THE INVENTION

The present invention relates to an apparatus (also referred to herein as a “flask” or “formula flask”) and to a method of preparing temperature sensitive beverages such as baby formula or tea. The disclosed embodiments enable preparation of such beverages at a more precise temperature than is typically attained.

According to one aspect, an apparatus for preparing a temperature sensitive beverage (e.g., baby formula, tea, and the like) having a body, base, and a mouth is disclosed. The apparatus also has one or more indicia, which can be quantity indicia (QI) or level indicia (LI). Various embodiments of the present invention have only LI, only QI, or both LI and QI. Some embodiments have only one LI (“level indicium” in this case, the same abbreviation being used for both the singular and plural forms herein), one QI (“quantity indicium” in this case, the same abbreviation being used for both the singular and plural forms herein), or one each of LI and QI. The body connects the base and the mouth. The indicia indicate the total amount desired but actually correspond to a first volume to be heated which is equivalent to a percentage (e.g., between 15% and 40%) of the total amount. The indicia allow a user to fill a second container (e.g., a baby bottle) to the total amount desired, and pour a first volume of liquid into the apparatus of the present invention, leaving a second volume of unheated liquid at the first temperature (e.g., room temperature, refrigeration temperature, or freezing temperature) in the second container. The first volume of liquid is poured into the apparatus according to the indicia. The first volume is heated from the first temperature to a second temperature (e.g., boiling temperature) in the apparatus. The user mixes the first volume of heated liquid and second volume of unheated of liquid in the second container to thereby obtain the total amount of baby formula at the desired temperature (e.g., body temperature) in the second container. In some embodiments, the indicia (QI and/or LI) display the total amount of final liquid, but actually demarcate level of the heated liquid calculated as described herein. In certain embodiments, the liquid is water. In particular embodiments, the heated liquid is heated to approximately its boiling temperature. The temperature of the unheated liquid, in alternative embodiments, can be a room temperature (e.g., 20° C.), a refrigerator temperature (e.g., 4° C.), or a freezing temperature (e.g., 0° C.). An example of an embodiment for use with a room temperature liquid is an apparatus that can be filled with liquid levels that are approximately 20% of what its indicia (QI and/or LI) indicate (e.g., for a total needed amount of 6 oz, the indicia indicate 6 oz, whereas the actual amount of liquid in the apparatus, if filled to the 6 oz line, is 1.2 oz). Another embodiment, for liquids at a typical refrigeration temperature, has its actual levels at 34% of what its indicia show. Yet another embodiment, for liquids at approximately 0° C. (e.g., temperature of liquid water as it exists in a mixture of liquid water and ice water), has its actual levels at 37% of what its indicia show.

According to an additional aspect of the present invention, a method of preparing a temperature sensitive beverage has the steps of selecting a total amount of a temperature sensitive beverage desired, filling the apparatus up to a level indicated by the indicia with a liquid (the first volume), leaving a second volume of liquid in the second container (e.g., a baby bottle) at a first temperature, heating the liquid having the first volume from a first temperatures to a second temperature, and mixing heated first volume of liquid with the unheated second volume of liquid. The level of liquid to fill the apparatus is indicated by indicia (QI, LI, or both) that conveniently show the total amount desired. The amount of unheated liquid (the second volume) to mix with the heated one is the difference between the total amount desired and the heated amount (the first volume). In certain embodiments, the method includes combining the liquid with a baby formula powder or a baby formula concentrate. Such a step of combining can be done at any stage, for example after obtaining the final mixture liquid at the desired temperature, or with the heated or unheated liquid before mixing (or even before separating) them. In particular embodiments, the liquid is a ready-to-feed baby formula. In other embodiments, the liquid is substantially water. In parallel with the embodiments related to the usage of a formula flask, the unheated liquid can be at a room temperature, at a refrigeration temperature, or at a freezing temperature, and the percentage of the heated liquid compared to the total amount of baby formula desired, for the above temperatures, can be 20%, 34%, or 37%, respectively.

In a particular embodiment, the method has the step of filling a baby bottle with room temperature water in an amount that corresponds to the total amount of baby formula desired. Water need not be pure; it can be tap water for example. Then, from this baby bottle, an amount is transferred into a formula flask. This transferred amount is indicated by one or more indicia (e.g., in the form of lines, numbers, or both) that actually show the total amount of water in the original baby bottle. However, the transferred amount is a calculated amount that is less than the total amount (e.g., a percentage) of formula needed. The method has the further steps of heating this liquid in the formula flask and then transferring it back into the original baby bottle, in effect mixing it with the unheated water. The resulting mixture, because of the calculated amount of water in the formula flask that corresponds to (e.g., its meniscus aligns with) one or more indicia showing the total amount of baby formula needed, will be at a temperature substantially close to that of the human body.

The present invention further includes systems having the flask or apparatus described herein and a second container such as a baby bottle or a tea cup/mug.

The present invention allows preparation of temperature sensitive beverages such as baby formulas with ease and precision. While manual methods of heating and then cooling a liquid are likely to miss an optimal temperature, such as the body's temperature, for the formula, the disclosed embodiments allow attainment of a final baby formula temperature that is closer to a desired optimal temperature. In addition, because heating involves a lesser amount of liquid, the heating step is faster. The heating can be made even faster by using a microwave oven, which would not have been practical with the larger amount of liquid due to uneven heating. The ability to reach the final desired temperature with a quick mixing, without any waiting period for a cooling, makes this an even faster way to prepare a baby formula or tea. Finally yet importantly, because the apparatus and the method can be used with minimal equipment, using them does not impart any significant financial burden on families.

### BRIEF DESCRIPTION OF THE DRAWINGS

The foregoing and other objects, features, and advantages of the invention will be apparent from the following more particular description of preferred embodiments of the invention, as illustrated in the accompanying drawings in which parts are referred to by reference characters across views. The drawings are not necessarily to scale, emphasis instead being placed on illustrating the principles of the invention.

FIG. 1 is a schematic of a perspective view of a formula flask showing, among other parts, body and base of the flask.

FIG. 2 is a schematic of a front view of a formula flask showing, among other parts, level and quantity indicia.

FIG. 3 is a schematic of a top view of a formula flask showing, among other parts, mouth of the flask.

### DETAILED DESCRIPTION OF THE INVENTION

A description of preferred embodiments of the invention follows.

Embodiments of the present invention include apparatuses, methods, and kits that can be used with any temperature sensitive liquid. A variety of beverages can be prepared at a desired temperature by using the methods and devices disclosed herein. Some of the examples of beverages that can be prepared at a desired temperature using the embodiments of the present invention include baby formula, tea, coffee, chocolate beverages, maize beverages, rice drinks, soft drinks, soda, fruit juices, vegetable juices, milkshakes, water, and cocktails. Different beverages have different optimal temperatures for their consumption, and also different ranges at which they can be consumed. Even when a certain drink is typically consumed at a low temperature, it may be safer to drink it at a slightly higher temperature if a person (e.g., a baby, a child, or an adult) is sick or simply not tolerant to some temperatures (e.g., due to having dental sensitivity). Other examples of drinks that can be prepared with the use of disclosed embodiments include tea (e.g., flavored teas, green tea, herbal tea), cappuccino, espresso, frappe, mocha, latte, café au lait, hot cider, milk, chai, hot chocolate, and lemonade.

With respect to baby formula, while such formulas can be provided to a baby at a variety of temperatures, because breastfeeding naturally supplies milk at the body's temperature, it is desirable to provide a baby formula at a similar temperature. Another reason to heat a baby formula above room temperature is to kill certain disease causing agents, such as bacteria. For example, it has been known that C. sakazakii can remain infectious in baby formulas prepared at or below room temperature. Although some formulas in the market are specifically labeled, such as “infant formula”, the embodiments of the present invention can be used with any formula that can be fed to a baby, and are not restricted to any age group.

Baby formulas can be purchased in three main forms: powder, concentrate, and ready-to-feed. Powder formulas need to be dissolved in a liquid, typically water, to prepare the final formula. The term “formula” without a modifier, as used herein, refers to the final solution that has the intended concentrations of the ingredients of the initial form of the formula, such as powder. The starting forms of the formulas are referred to herein with their appropriate modifiers (e.g., adjectives that may exist anywhere in the same sentence), such as in “powder formula”, “formula powder”, “formula concentrate”, or “initial form of the formula”. Formulas that are supplied as concentrates are typically in liquid form, and need to be diluted with a liquid, typically water, to achieve the proper final concentrations of their ingredients. Ready-to-feed formulas need not be diluted, but may still need to be heated to a suitable temperature.

A suitable body temperature to which a formula can be heated is typically 37° C., even though there can be some variation from person to person, since the quoted 37° C. is an average and thus an individual's optimal body temperature can be less or more than that (e.g., by one degree). Sometimes, effectively sacrificing precision for accuracy, a parent may want to heat to a slightly lesser temperature than 37° C., since higher temperatures can be potentially more dangerous than lower ones. Thus, an exemplary final temperature to aim at can be 36° C. as well as the more normal 37° C. Such temperatures that approximate human body temperature are referred to herein as body temperature; therefore, the term “approximately” includes values that are within a certain percentage error (e.g., 1%, 2%, 3%, 5%, 10%) of a given value. The same term, approximately, is also similarly used herein for other variables such as other types of temperatures and volume values.

With respect to tea, different types of teas have different optimal temperatures at which they should be prepared for best taste. For instance, varieties of loose tea (e.g., loose leaf tea including green tea, white tea, and black tea; loose leaf tea blended with fruits such as strawberries and/or blueberries; loose leaf tea with flowers such as lavender, jasmine, or roses) require a brewing (e.g., steeping, infusion) with water at a certain temperature for a certain time period. If some types of teas are infused with water at a temperature higher than their optimal one, they will taste bitter (white, green, and black teas are susceptible to such bitterness). Combining different teas also requires them to be prepared at a certain temperature (most typically at the lowest of the range of temperatures for the individual teas). Common optimal temperatures for brewing loose teas range from 175° F. to 208° F. Converting these temperatures from Fahrenheit to Celsius (Degree in Celsius=(Degree in Fahrenheit−32)*5/9) gives an approximate range of 79° C. to 98° C., with an average around 88° C. As apparent, these temperatures are lower than the boiling temperature of water; thus, if water at its boiling temperature is used, the optimal taste of the tea will be missed. Certain teas brewed at boiling temperatures have a more bitter taste.

Phase transition temperatures of the liquids used, especially those of the most common one, water, are of particular importance to the present invention. Water has a boiling temperature, at which it can change from liquid to gas (or from gas to liquid), approximately around 100° C., depending on the types and degree of impurities present in it and also depending on the pressure of the environment. Subject to similar variables, the freezing temperature of water is around 0° C. under normal conditions. For brevity, most common temperatures (e.g., boiling temperature, freezing temperature) described herein assume normal conditions (e.g., no impurities present, and under atmospheric pressure at sea level of approximately one atmosphere). Depending on what geographical area or environment is of interest, the equations and explanations provided herein are sufficiently general to modify the embodiments of the present invention to make them suitable for any circumstance. Another temperature that is referred to herein is “room temperature”, which typically is 20° C.-25° C., but for clarity is used herein to refer to approximately 20° C.

Obtaining a liquid at its boiling temperature can be accomplished in several ways. For example, water can be heated in a pan over a conventional oven, or in a flask within a microwave oven until it starts boiling. Obtaining a liquid at its freezing temperature is also straightforward. For example, liquid water from a refrigerator can be mixed with ice water and allowed to cool to 0° C. While these two temperatures seem to be more precisely attainable than a relatively fluctuating environmental temperature, a home with a carefully controlled room temperature (e.g., 20° C.) can also supply a reliable source of a liquid with well-defined temperature.

The present invention utilizes a physical relationship describing the final temperature attained after mixing a number of different substances, a general form of which is provided in Equation 1:

$${T}_{F} = \frac{{\sum }_{i = 1}^{n} {m}_{i} \times {c}_{i} \times {T}_{i}}{{\sum }_{i = 1}^{n} {m}_{i} \times {c}_{i}}$$

In Equation 1, “m” stands for the mass of a substance, which can have the units of kg, “c” for specific heat capacity, which can have the units of kJ/(kg×° C.), and “T” for temperature, which can have units of ° C. Many other sets of units can be used in any of the equations herein as long as they are internally consistent. The subscripts “i” denote distinct substances, for example m₁ being the mass of the first substance mixed, m₂ being the mass of the second substance being mixed, etc. The subscript “F” refers to the final substance, for example T_{F} being the temperature of the final substance. For mixing only two substances, Equation 1 simplifies to Equation 2:

$${T}_{F} = \frac{{m}_{1} \times {c}_{1} \times {T}_{1} + {m}_{2} \times {c}_{2} \times {T}_{2}}{{m}_{1} \times {c}_{1} + {m}_{2} \times {c}_{2}}$$

In Equation 2, the symbols have the same meanings as they did in Equation 1. When the two mixed substances have the same specific heat capacities (c₁=c₂), such as when a liquid at one temperature is mixed with the same type of liquid (e.g., water) at another temperature, Equation 2 further simplifies to Equation 3:

ρ×T_{B}^{(° C.)}+(1−ρ)×T_{R}^{(° C.)}=T_{F}^{(° C.)}

In Equation 3, to facilitate interpretation of the symbols, letter subscripts have been used instead of numeric subscripts. For example, the subscript “B” refers to the first substance, which, as later will become apparent in an embodiment, can be water at its boiling temperature (“B” taken from the first letter of “boiling”). Similarly, the subscript “R” refers to the second substance, which, in an embodiment, can be water at room temperature (“R” taken from the first letter of “room”). The superscripts (° C.) simply denote the unit of choice in this description, but are not binding. None of these symbols is binding on the temperature of the liquid, they are only intended for facilitating interpretations of the equations. For example, the “R” liquid can be at temperatures that are different from room temperature. Finally, the character “ρ” stands for the fraction of the first liquid (the “B” liquid). By comparing Equation 3 with Equation 2, it can be seen that p corresponds to m₁/(m₁+m₂). For cases in which the two mixed liquids are of the same type, for example when both are water, the same ratio ρ can be obtained from the volumes of the liquids instead of the masses, since mass=density×volume, and since the densities would be the same for the two liquids of the same type. Usage of volumes can be more convenient, since it often is easier to measure volumes of liquids. Once the volumes of two liquids are known, it is straightforward to obtain the value of ρ. For example if the first liquid has a volume of 2 ounces, and the second one a volume of 8 ounces, then p would be equal to 2/(2+8) which is 0.2. The value of ρ can also be directly obtained from the percentage of the first liquid, as ρ is simply the fractional representation of the same percentage (e.g., a percentage of 20 that corresponds to a fractional value of 0.2). Any volume units can be used, as long as they are the same for the two liquids, or as long as the differences in the units are corrected for. Equation 3 can be rearranged in many ways, for example the value of room temperature that would be useful to achieve a certain final temperature with a certain value of ρ can be obtained from Equation 4:

$${T}_{R}^{( ° C . )} = \frac{{T}_{F}^{( ° C . )} - ρ \times {T}_{B}^{( ° C . )}}{1 - ρ}$$

Some exemplary values derived from Equation 4 for mixing two volumes of water, one being at a boiling temperature of 100° C., for some values of ρ are listed in Table 1, where the column “% B” indicates the percentage of the boiling water, the column T_{R}(° C.)_F(36) indicates the temperature of the second volume of water that, after mixing with an indicated percentage of boiling water, would create a final volume of water at 36° C., and the column T_{R}(° C.)_F(37) indicates the temperature of the second volume of water that, after mixing with an indicated percentage of boiling water, would create a final volume of water at 37° C. From the two rows shown in bold, it can be seen that, to achieve a final mixture at 36° C., boiling hot water at an amount corresponding to 20% of the final volume should be mixed with a remaining percentage (80%) of the second liquid at a temperature of 20° C. From the other row shown in bold, it can be seen that to reach the same final temperature of 36° C. with a first liquid percentage of 36, the second liquid needs to be at a temperature of 0° C.

TABLE 1

| % B | T_{R}(° C.)_F(36) | T_{R}(° C.)_F(37) |
|---|---|---|
| 2 | 34.69 | 35.71 |
| 4 | 33.33 | 34.38 |
| 6 | 31.91 | 32.98 |
| 8 | 30.43 | 31.52 |
| 10 | 28.89 | 30.00 |
| 12 | 27.27 | 28.41 |
| 14 | 25.58 | 26.74 |
| 16 | 23.81 | 25.00 |
| 18 | 21.95 | 23.17 |
| 20 | 20.00 | 21.25 |
| 22 | 17.95 | 19.23 |
| 24 | 15.79 | 17.11 |
| 26 | 13.51 | 14.86 |
| 28 | 11.11 | 12.50 |
| 30 | 8.57 | 10.00 |
| 32 | 5.88 | 7.35 |
| 34 | 3.03 | 4.55 |
| 36 | 0.00 | 1.56 |

Note that % B refers to the percentage of the boiling water which is an equivalent number to “ρ”, which is represented as a fraction instead of a percentage.

Similarly, rearranging Equation 3 in a different way, the value of p needed to obtain a desired final temperature from two liquids can be obtained from Equation 5:

$$ρ = \frac{{T}_{F}^{( ° C . )} - {T}_{R}^{( ° C . )}}{{T}_{B}^{( ° C . )} - {T}_{R}^{( ° C . )}}$$

Analogously to Table 1, Table 2 shows some values derived from Equation 5. In Table 2, column T_{R}(° C.) refers to the temperature of the second liquid in Celsius, % B_F(36) refers to the percentage of the first liquid, which is at a temperature of 100° C., that needs to be mixed with the indicated second liquid to reach 36° C., and % B_F(37) refers to the percentage of the first liquid, which is at a temperature of 100° C., that needs to be mixed with the indicated second liquid to reach 37° C. Some values of practical interest are shown in bold, for example, it can be seen that to obtain a final mixture at 36° C. from a second liquid (the “R” liquid) at 4° C. (a typical temperature for a liquid kept in a refrigerator), one needs to mix 33.33% of the boiling liquid with a remaining percentage (66.67%) of the second liquid at 4° C.

TABLE 2

| T_{R}(° C.) | % B_F(36) | % B_F(37) |
|---|---|---|
| 2 | 34.69 | 35.71 |
| 4 | 33.33 | 34.38 |
| 6 | 31.91 | 32.98 |
| 8 | 30.43 | 31.52 |
| 10 | 28.89 | 30.00 |
| 12 | 27.27 | 28.41 |
| 14 | 25.58 | 26.74 |
| 16 | 23.81 | 25.00 |
| 18 | 21.95 | 23.17 |
| 20 | 20.00 | 21.25 |
| 22 | 17.95 | 19.23 |
| 24 | 15.79 | 17.11 |
| 26 | 13.51 | 14.86 |
| 28 | 11.11 | 12.50 |
| 30 | 8.57 | 10.00 |
| 32 | 5.88 | 7.35 |
| 34 | 3.03 | 4.55 |
| 36 | 0.00 | 1.56 |

The term “correspond”, when used in the context of a volume, refers to the amount of that volume, whereas when used in the context of an indicium, refers to the printed value of the indicium and not necessarily the actual volume marked by the indicium. Similarly, the term “directly correspond”, when used in the context of indicia, refers to the printed value and not necessarily the volume enclosed by a flask up to the indicated mark. As an example, an indicium of “6 oz” printed on a flask might “directly correspond” to the total amount of a final mixture, whereas the volume of liquid enclosed by the flask, when filled up to the “6 oz” mark, might only be 1.2 oz.

Using the equations provided herein, a calculation can be performed to determine the percentage of the desired final amount of water that should be heated to its boiling temperature to obtain a final mixture of the desired amount of water at the desired temperature. For example, for the case of preparing a tea, if the tea has an optimal brewing temperature of 79° C., then the percentage of room temperature water to boil is 74%, the percentage of refrigerator temperature water to boil is 78%, and the percentage of freezing temperature water to boil is 79%. Similarly, if the tea has an optimal brewing temperature of 88° C., then the percentage of room temperature water to boil is 85%, the percentage of refrigerator temperature water to boil is 87%, and the percentage of freezing temperature water to boil is 88%. Again similarly, if the tea has an optimal brewing temperature of 98° C., then the percentage of room temperature water to boil is 97%, while the percentage of refrigerator or freezing temperature water to boil is approximately 98%. The above percentages have been rounded to two significant digits, and as can be inferred, the methods disclosed are more useful when the desired temperature is not too close to the boiling temperature of water.

The term “flask” is used herein in a very general sense, and need not have a base wider than its body or mouth. Any container, whether cylindrical, tubular, conical, etc., can be used.

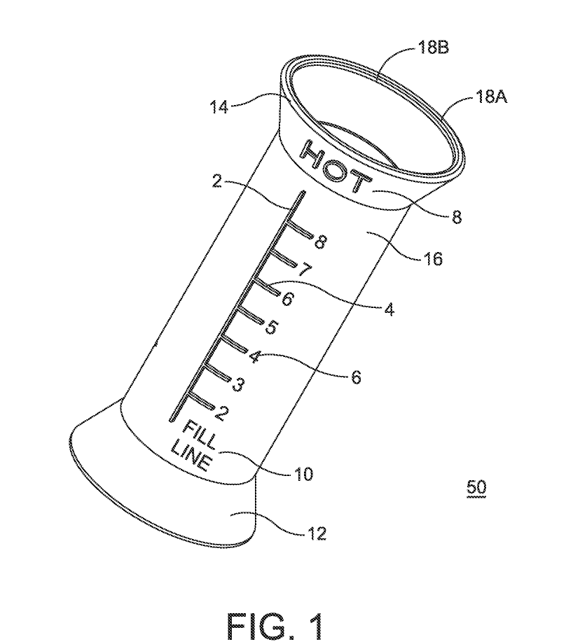

Now referring to FIG. 1, formula flask 50 is shown to have mouth 14, base 12, and body 16. These three parts can be of varying sizes relative to each other, and in some embodiments, they can be one continuous piece. For example, for a flask that is simply a unified cylindrical flask throughout, the base would refer to the bottom portion (e.g., the lowest 10% of the height of the flask) of it that is closed, and the mouth would refer to the upper portion (e.g., the highest 10% of the height of the flask) of it that accepts liquids. In the referred figure, the base expands to a greater diameter than the body, effectively stabilizing the flask. The mouth similarly expands to a diameter greater than that of the body, making it easier to pour liquids into the flask. Mouth 14 is seen in the figure to have outer lip 18A and inner lip 18B. These two are simply opposite sides of a wide lip that this particular embodiment has. Some embodiments have only one lip.

FIG. 1 also shows guide 2, marking 8, and label 10. The guide is optional in some embodiments, but is shown here in part because it provides a visual aid in determining whether the flask is standing vertical or not. The marking is intended as a warning in this embodiment, and provides a cautionary message to the user that the contents may be hot. In other embodiments, markings with other purposes can be used, for example warnings to not exceed a certain volume or common commercial markings of a company (e.g., trademark of a flask manufacturing company, or advertisement of an infant formula manufacturer). The label can also serve many different functions, including the ones mentioned for the marking Label 10, in the referred figure, is shown to indicate the nature of the indicia printed onto the body of the flask. In some embodiments, the marking and the label can be at interchanged positions (e.g., label near the mouth, and making near the base). Either the marking or the label can be used to display the units of volume that the flask can contain. In some embodiments, one or both of the marking and label can be omitted.

Additionally, FIG. 1 shows two types of indicia. Level indicium 4 is shown as a line or the series of lines on the body of the flask to indicate the point at which the liquid should be poured. In FIG. 1, quantity indicium 6 indicates the total final volume/amount of the temperature sensitive beverage after heated and unheated amounts are mixed. The depicted flask has a multiplicity of such indicia. The level indicia enable a user to fill the flask up to a desired volume by aligning the upper meniscus of the liquid inside with a level indicium. The quantity indicia enable determination of the amount of liquid that fills the flask near the quantity indicium or near the accompanying (e.g., nearest) level indicium. In this particular embodiment, the shown quantity indicia have the units of ounces; so, the quantity of liquid that fills the flask up to the line next to the number 6 is intended for a volume of 6 ounces (though that is not necessarily the amount of liquid that fills the flask up to that line).

Even though the embodiment shown in FIG. 1 can be adapted to numerous alternative embodiments, six separate ones will be explained herein further. In a first embodiment, the quantity indicia show a series of total volumes of liquid for a baby formula, whereas the corresponding volume of liquid enclosed by the flask when filled to the shown indicia is only 20% of the indicated value. Such a flask can be used to prepare baby formula at body temperature, for example by first filling a baby bottle with a desired total volume of water at room temperature, filling the flask up to an indicium corresponding to the total volume desired with water from the baby bottle, microwaving the flask until the water in it starts boiling, mixing the water in the flask with the remaining water in the baby bottle, and finally adding the baby formula powder. In a second embodiment, the quantity indicia show a series of total volumes of liquid for a baby formula, whereas the corresponding volume of liquid enclosed by the flask when filled to the shown indicia is only 34% of the indicated value. Such a flask can be used to prepare baby formula at body temperature via a similar method to the one outlined for the first embodiment detailed above, except that instead of room temperature water, refrigerator temperature water can be used as the starting water. In a third embodiment, the quantity indicia show a series of total volumes of liquid for a baby formula, whereas the corresponding volume of liquid enclosed by the flask when filled to the shown indicia is only 37% of the indicated value. Such a flask can be used to prepare baby formula at body temperature via a similar method to the one outlined for the first embodiment detailed above, except that instead of room temperature water, freezing temperature water (e.g., from a mixture of ice and water) can be used as the starting water. In a fourth embodiment, a flask can be prepared for a fixed volume of total formula desired, but printed with indicia for different starting temperatures of water. For example, a flask for 4 ounces of total formula desired would have an indicium (QI, LI, or both) for freezing temperature water, another for refrigerator temperature water, and yet another for room temperature water as the starting one. A fifth embodiment can be similar to the fourth one, with the exception of being designed for a total volume of 6 ounces. A sixth embodiment, parallel of the fifth and fourth ones, can be designed for a total volume of 8 ounces. In these embodiments, the percentage of the liquid that actually is enclosed by the flask is hidden from the user, so that the user will not need to use any equations or calculate any amounts. The user only needs to know the total amount desired and the approximate initial temperature of the liquid. It should be apparent that many additional embodiments are possible that use the same concepts described herein.

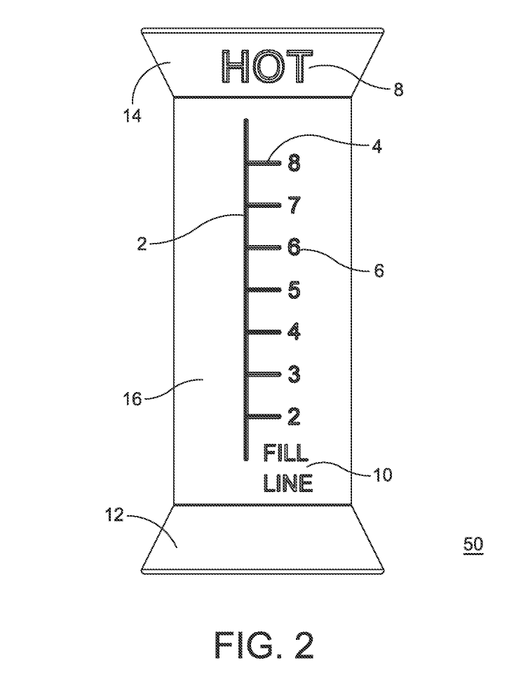

Turning our attention to FIG. 2, shown is flask 50 with a front view. Shown are guide 2, level indicium 4, quantity indicium 6, marking 8, label 10, base 12, mouth 14, and body 16. The part at which the base is closed can be at the interface where the body ends and the base starts, as it is in this figure (even though not directly visible, this can be inferred from the spacing between the indicia). In alternative embodiments, the flask can be closed at any plane or area of the base or body.

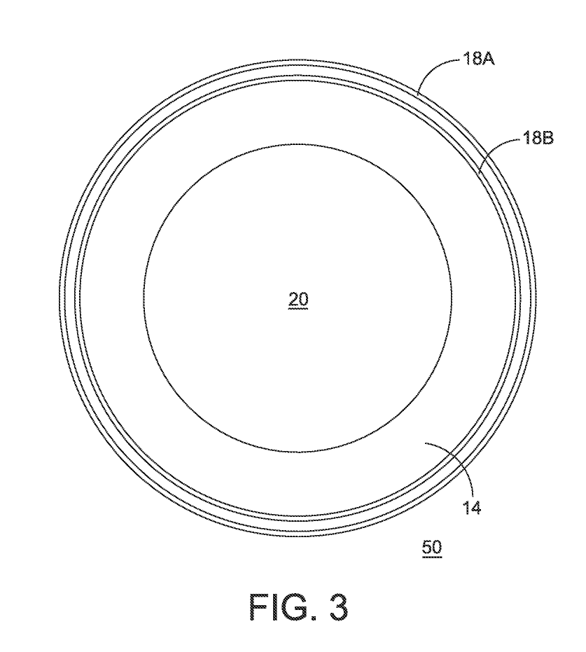

Referring to FIG. 3, flask 50 is seen from a top view. Shown are mouth 14, outer lip 18A, and inner lip 18B. Even though the two lips seem to be separate in this figure, in some embodiments they either are a single lip or are continuously linked. Also shown in this figure is inner base surface 20, which enables containment of liquids in the flask.

The apparatus of the present invention can be made from any material now known or later developed in the future so long as the material is safe for use as beverage containers and can be heated (e.g., microwaved) when liquid is present therein. The parts of the apparatus can be made from one or more than one material. For example, the body can be made from glass and the lip and base can be made from microwavable plastic. Examples of materials that can be used to make the apparatus of the present invention include, e.g., glass, plastic, silicon, rubber and the like.

### EXEMPLIFICATION

Before the manufacturing of the flask, a three-dimensional computer model of the flask has been designed with SolidWorks (Dassault Systèmes SolidWorks Corporation, Waltham, Mass.). One of the created flask models, as well as some of the prototypes, had the following dimensions: An 8.125 mm (millimeter) distance between each level indicia that incremented by 1 US fluid ounces (approximately equivalent to 29.5735 milliliters), a 34.038 mm radius for the body of the flask, a 45.931 mm radius for the radii of the bottom and top edges (the widest portions of the base and the mouth), a 104.139 mm distance between the topmost and bottommost edges of the flask, a 12.846 mm height for each of the faces of the base and the mouth, and a 78.447 mm height for the body portion of the flask. The flask had seven level indicia and seven quantity indicia, the amount of liquid between consecutive indicia corresponding to 1 oz.

A formula flask has been manufactured by first exporting a CAD (computer aided design) model from SolidWorks for rapid prototyping, and then fabricated using 3D printing. The initial prototypes were made from ACURA® CLEARVUE™ material provided by 3DSYSTEMS™ (3D systems Corporation, 333 Three D Systems Circle, Rock Hill, S.C. 29730 U.S.A). To make the prototypes microwave safe, they were also manufactured from glass (especially for the body part), and optionally with additional plastic or rubber (e.g., silicone) for the base and/or mouth parts. An additional model was created in its entirety from molded plastic. A created prototype a total volume capacity of more than 9 ounces and indicia for 2, 3, 4, 5, 6, 7, and 8 ounces. The flask had a body, a base with a diameter continuously increasing from that of the body (the values being as indicated for the SolidWorks model), and a mouth with a diameter continuously increasing from that of the body (the values being as indicated for the SolidWorks design). The flask has been manufactured to be compatible with microwave ovens, and tested up to the boiling temperature of water to follow the methods described herein.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1) An apparatus for preparing a total amount of baby formula at a desired temperature, wherein the apparatus is used together with a second container, wherein the apparatus comprises:
a) a body having a first end and a second end;
b) a mouth at the first end of the body;
c) a base at the second end of the body; and
d) one or more indicia on the body that indicate the total amount but correspond to a first volume to be heated that is equivalent to a percentage of the total amount, wherein the one or more indicia are selected from the group consisting of: quantity indicium, level indicium, and a combination thereof;
wherein the one or more indicia allow a user to heat the first volume of liquid from a first temperature to a second temperature in the apparatus, leaving a second volume of unheated liquid at the first temperature in the second container, wherein the user mixes the first volume of heated liquid and second volume of unheated liquid in the second container to thereby obtain the total amount of baby formula at the desired temperature in the second container.

2) The apparatus of claim 1, wherein the one or more indicia, as displayed on the body, directly correspond to the total amount of formula.

3) The apparatus of claim 2, wherein the liquid is substantially water.

4) The apparatus of claim 2, wherein the second temperature is approximately the boiling temperature of the liquid, and wherein the desired temperature is approximately 37° C.

5) The apparatus of claim 4, wherein the first temperature is approximately a room temperature.

6) The apparatus of claim 5, wherein the first volume as indicated by the one more indicia is about 20% of the total amount of formula.

7) The apparatus of claim 4, wherein the first temperature is approximately a refrigerator temperature.

8) The apparatus of claim 7, wherein the first volume as indicated by the one or more indicia is about 34% of the total amount of formula.

9) The apparatus of claim 4, wherein the first temperature is approximately a freezing temperature of the liquid.

10) The apparatus of claim 9, wherein the first volume as indicated by the one or more indicia is about 37% of the total amount of formula.

11) An apparatus for preparing a total amount of a temperature sensitive beverage at a desired temperature, wherein the apparatus is used together with a second container, wherein the apparatus comprises:
a) a body having a first end and a second end;
b) a mouth at the first end of the body;
c) a base at the second end of the body; and
d) one or more indicia on the body that indicate the total amount but correspond to a first volume to be heated that is equivalent to a percentage of the total amount, wherein the one or more indicia are selected from the group consisting of: quantity indicium, level indicium, and a combination thereof;
wherein the one or more indicia allow a user to heat the first volume of liquid from a first temperature to a second temperature in the apparatus, leaving a second volume of unheated liquid at the first temperature in the second container, wherein the user mixes the first volume of heated liquid and second volume of unheated liquid in the second container to thereby obtain the total amount of the temperature sensitive beverage at the desired temperature in the second container.

12) A method of preparing a total amount of baby formula at a desired temperature using an apparatus that comprises a body having a first end and a second end; a mouth at the first end of the body; a base at the second end of the body; and one or more indicia on the body that indicate the total amount but correspond to a first volume to be heated that is equivalent to a percentage of the total amount, wherein the one or more indicia are selected from the group consisting of: quantity indicium, level indicium, and a combination thereof; the method comprising the steps of:
a) filling a baby bottle with a liquid of the total amount of baby formula at a first temperature, wherein the liquid is substantially water, and wherein the first temperature is approximately a room temperature;
b) filling the apparatus with the liquid from the baby bottle up to the first volume indicated by one or more indicia on the apparatus, thereby leaving a second volume of unheated liquid at the first temperature in the baby bottle;
c) heating the liquid in the apparatus to a second temperature, wherein the second temperature is approximately 100° C.; and
d) combining the first volume of heated liquid at the second temperature with the second volume of unheated liquid at the first temperature in the baby bottle;
to thereby obtain the total amount of baby formula at the desired temperature.

13) The method of claim 12, further comprising the step of combining the liquid with an amount of baby formula powder or baby formula concentrate.

14) The method of claim 12, wherein the liquid is a ready-to-feed baby formula.

15) The method of claim 12, wherein the liquid is substantially water.

16) The method of claim 12, wherein the second temperature is approximately the boiling temperature of the liquid, and wherein the desired temperature is approximately 37° C.

17) The method of claim 16, wherein the first temperature is approximately a room temperature.

18) The method of claim 17, wherein the first volume as indicated by the one more indicia is about 20% of the total amount of formula.

19) The method of claim 16, wherein the first temperature is approximately a refrigerator temperature.

20) The method of claim 19, wherein the first volume as indicated by the one or more indicia is about 34% of the total amount of formula.

21) The method of claim 16, wherein the first temperature is approximately a freezing temperature of the liquid.

22) The method of claim 21, wherein the first volume as indicated by the one or more indicia is about 37% of the total amount of formula.

23) A method of preparing a total amount of a temperature sensitive beverage at a desired temperature using an apparatus that comprises a body having a first end and a second end; a mouth at the first end of the body; a base at the second end of the body; and one or more indicia on the body that indicate the total amount but correspond to a first volume to be heated that is equivalent to a percentage of the total amount, wherein the one or more indicia are selected from the group consisting of: quantity indicium, level indicium, and a combination thereof; the method comprising the steps of:
a) filling a second container with a liquid of the total amount of the temperature sensitive beverage at a first temperature, wherein the liquid is substantially water, and wherein the first temperature is approximately a room temperature;
b) filling the apparatus with the liquid from the second container up to the first volume indicated by one or more indicia on the apparatus, thereby leaving a second volume of unheated liquid at the first temperature in the second container;
c) heating the liquid in the apparatus to a second temperature, wherein the second temperature is approximately 100° C.; and
d) combining the first volume of heated liquid at the second temperature with the second volume of unheated liquid at the first temperature in the second container;
to thereby obtain the total amount of the temperature sensitive beverage at the desired temperature.

24) A system for preparing a total amount of baby formula at a desired temperature, wherein the system comprises:
a) an apparatus having:
i) a body having a first end and a second end;
ii) a mouth at the first end of the body;
iii) a base at the second end of the body; and
iv) one or more indicia on the body that indicate the total amount but correspond to a first volume to be heated that is equivalent to a percentage of the total amount, wherein the one or more indicia are selected from the group consisting of: quantity indicium, level indicium, and a combination thereof;
wherein the one or more indicia allow a user to heat the first volume of liquid from a first temperature to a second temperature in the apparatus, leaving a second volume of unheated liquid at the first temperature in a baby bottle, wherein the user mixes the first volume of heated liquid and second volume of unheated liquid in the baby bottle to thereby obtain the total amount of baby formula at the desired temperature in the baby bottle; and
b) the baby bottle.

25) A system for preparing a total amount of a temperature sensitive beverage at a desired temperature, wherein the system comprises:
a) an apparatus having:
i) a body having a first end and a second end;
ii) a mouth at the first end of the body;
iii) a base at the second end of the body; and
iv) one or more indicia on the body that indicate the total amount but correspond to a first volume to be heated that is equivalent to a percentage of the total amount, wherein the one or more indicia are selected from the group consisting of: quantity indicium, level indicium, and a combination thereof;
wherein the one or more indicia allow a user to heat the first volume of liquid from a first temperature to a second temperature in the apparatus, leaving a second volume of unheated liquid at the first temperature in a second container, wherein the user mixes the first volume of heated liquid and second volume of unheated liquid in the second container to thereby obtain the total amount of temperature sensitive beverage at the desired temperature in the second container; and
b) the second container.
